(19) United States
(12) Patent Application Publication
(10) Pub. No.: US 2013/0337427 A1
(43) Pub. Date: Dec. 19, 2013

(54) ELECTRONIC BOOK, METHOD AND DEVICE FOR IDENTIFYING ELECTRONIC BOOK PAGE NUMBER

(71) Applicant: Ziwen ZHONG, Shenzhen (CN)

(72) Inventor: Ziwen ZHONG, Shenzhen (CN)

(21) Appl. No.: 13/973,353

(22) Filed: Aug. 22, 2013

Related U.S. Application Data
(63) Continuation-in-part of application No. PCT/CN2011/071642, filed on Mar. 9, 2011.

(30) Foreign Application Priority Data
Feb. 24, 2011 (CN) 201110044744.X

(51) Int. Cl. G09B 5/06

(52) U.S. Cl. CPC G09B 5/06
USPC 434/317

(57) ABSTRACT

Disclosed are an electronic book, as well as a method and device for identifying electronic book page numbers. The method includes positioning trigger pins and a contact end on a book spine. The contact end is electrically connected to a controller. When a page of the electronic book is flipped, two contact ends of a soft circuit, which is closely affixed on the book spine, are made conducting by squeezing a positioning trigger pin. The conduction signal of the contact ends are received and the page number of the flipped page is identified according to the received signal. The preset content of the book page is played through the controller which is electrically connected to the soft circuit. Positioning trigger pins and the contact end are arranged on the low parts of the book spine surface, which is formed naturally by mounting and bending pages.

### CROSS-REFERENCE TO RELATED PATENT APPLICATIONS

This application is a Continuation-in-Part of PCT Application Number PCT/CN2011/071642, filed Mar. 9, 2011, which claims priority from Chinese Application No. CN 201110044744.X, filed Feb. 24, 2011, each of which are hereby incorporated by reference in their respective entireties.

### TECHNICAL FIELD

The present invention relates to electronic book technology field, in particular to a method and device for identifying electronic book page number and to an electronic book.

### BACKGROUND

For normal books, words are printed on book pages and readers obtain messages from books by their visual sense. With the development of technology and the changing of practical demands, a new kind of electronic book hit the market. When reader flips a page of the electronic book, it can automatically and vocally play the content of the flipped page, such as printed content and background music, adding fun to reading and increasing reading efficiency.

The existing electronic books are provided with a page number identification device that can identify electronic book page number. The device comprises a controller and a page number sensor. Upon a page of the electronic book is flipped, the page number sensor can identify the flipped page number and send a signal to the controller. The controller then plays the content of the page according to the received signal.

In the prior art, the page number sensor of the page number identification device includes a soft circuit and a touch mechanism. One end of the soft circuit is connected into the controller and the other end is affixed on the book spine. The touch mechanism is also affixed on the book spine and should be conducted with a certain line of the soft circuit in advance. Upon a certain book page is flipped, the touch mechanism is consequently conducted with another corresponding line of the soft circuit, realizing the goals of identifying the page number and playing the content of the corresponding page. As the distance between the touch mechanism and the soft circuit varies with open angle of the book page, the touch mechanism of the prior art generally employs elastic materials, such as conductive rubber or metal dome, to ensure good contact. However, in practical assembly process, it is hard to mount and position the elastic touch mechanism precisely and uniformly because it is fixed with adhesive. Moreover, during use, the elastic touch mechanism tends to offset from its original place because the touch mechanism rubs against the soft circuit on the book spine. So it can not work reliably and the page number identification device is likely to identify no page number or wrong page number. Furthermore, unmanageable key sizes of the touch mechanism and complicated structure lead to low production efficiency and relatively high defect ratio and production cost. Besides, when a different page is flipped, the open angle that triggers the page is also different, lacking consistency.

Additionally, in the prior art, the touch mechanism has strict requirements on book page thickness. The mounted book pages should be thick enough to ensure enough room for the touch mechanism. However, if the touch mechanism is too thin, it may further reduce the reliability of operations and increase the difficulty and cost of part production.

### SUMMARY

The present invention is designed to provide a method and device for identifying electronic book page number, aims at solving such problems existing in current electronic book page number identification devices as inconvenient assembly, unreliable operations, low production efficiency, high production cost and strict requirements on book page thickness.

The present invention is realized through: a method for identifying electronic book page number, comprising: positioning trigger pins and a contact end are arranged on a book spine, the contact end being electrically connected to a controller; upon a page of the electronic book is flipped, conducting two contact ends, of a soft circuit which is closely affixed on the book spine, by squeezing a positioning trigger pin; receiving the conduction signal of the contact ends, identifying the page number of the flipped page according to the received signal, and playing the preset content of the book page through the controller electrically connected to the soft circuit.

According to the abovementioned method, the present invention provides an electronic book page number identification device, configured to automatically identify the page number of a page of an electronic book and play the content of the page; including a controller and a soft circuit electrically connected to the controller; one end of the soft circuit comprising a contact end which can be closely affixed on the book spine of the electronic book; wherein: the device also includes positioning trigger pins arranged at the contact end of the book spine; the contact end is electrically connected to the controller; the positioning trigger pin is electrically or non-electrically connected to the controller.

Further, the positioning trigger pin comprises a body and insertion pins which are arranged on the body and can be inserted into the book spine; the insertion pins are disposed on the contact end; the body contacts closely with the contact end.

Further, the body takes the shape of a cylinder and the insertion pin is of flat shape.

Further, the positioning trigger pin comprises a body; the positioning trigger pin is under the contact end of the soft circuit and between the soft circuit and the book spine; the contact end is electrically connected to the controller, while the positioning trigger pin is non-electrically connected to the controller.

Further, the body takes the shape of a cylinder.

Further, the soft circuit comprises a second line and a plurality of first lines that are independent of one another; the contact end comprises a first contact end which is on one end of the first line and a common contact end which is on one end of the second line; the positioning trigger pin is disposed on the common contact end.

Further, according to the order in which the page numbers of pages are arranged, each common contact end, two first contact ends on both sides of the common contact end and the positioning trigger pin arranged at the common contact end form a contact end group.

Further, if the electronic book page number identification device comprises a plurality of contact end groups, the contact end groups are staggered in the direction that the page numbers of pages are arranged.

Further, the soft circuit comprises a plurality of third lines that are independent of one another; the contact end is a third contact end which is on one end of the third line; the positioning trigger end is disposed on the third contact end.

The present invention also provides an electronic book, which includes a book body and the abovementioned electronic book page number identification device; the soft circuit of the device is affixed to the outermost page of the book body; the contact end is affixed to the book spine; the positioning trigger pin is arranged at the book spine.

Further, the book spine has high parts formed by mounting and bending book pages and low parts between pages; the high parts and low parts are distributed alternatively on the book spine; the contact end and the positioning trigger pin are arranged on the low parts.

By adopting the method of the present invention, the device designed with the method, electronic books with the device of the present invention and by the positioning trigger pin and the contact end that are directly arranged on the low parts of the book spine, the present invention provides novel method, simple structure, convenient assembly, thus has advantages of high production efficiency, low cost, no displacement of the positioning trigger pin during use, highly reliable operations, low requirements on book page thickness of the electronic book, so the applicability is strong.

### BRIEF DESCRIPTION OF THE DRAWINGS

FIG. 1 is a schematic front view of an electronic book page number identification device, according to a first embodiment of the present invention;

FIG. 2 is a schematic front view of an electronic book, according to a first embodiment of the present invention;

FIG. 3 is an enlarged schematic view for position A in FIG. 2;

FIG. 4 is a schematic front view of a book spine of an electronic book, according to a first embodiment of the present invention;

FIG. 5 is a schematic stereogram 1 of an electronic book, according to a first embodiment of the present invention;

FIG. 6 is a schematic stereogram 2 of an electronic book, according to a first embodiment of the present invention;

FIG. 7 is a schematic front view of a positioning trigger pin, according to a first embodiment of the present invention;

FIG. 8 is a schematic sectional view of a positioning trigger pin, according to a first embodiment of the present invention.

### DETAILED DESCRIPTION OF THE PREFERRED EMBODIMENTS

In order to make the present invention, technical scheme and advantages more clearly understood, the present invention will be described in further detail in connection with embodiments and with reference to the accompanying drawings. It should be understood that the embodiments described herein are only used for explaining the present invention, and are not intended to limit the present invention.

The present invention provides a method for identifying electronic book page number. The method includes: positioning trigger pins and a contact end are arranged on a book spine, the contact end being electrically connected to a controller; upon a page of the electronic book is flipped, conducting two contact ends, of a soft circuit which is closely affixed on the book spine, by squeezing a positioning trigger pin; receiving the conduction signal of the contact ends, identifying the page number of the flipped page according to the received signal, and playing the preset content of the book page through the controller electrically connected to the soft circuit.

In the method of the present invention, the positioning trigger pin is directly fixed on the book spine of the electronic book; two contact ends are conducted to each other by their squeezing with the positioning trigger pin. The invention presents novel method, simple structure, convenient assembly, thus has advantages of high production efficiency, low cost, no displacement of the positioning trigger pin during use, highly reliable operations, low requirements on book page thickness of the electronic book, so the applicability is strong.

On the basis of the abovementioned method, the present invention provides an electronic book page number identification device. The following will elaborate, with reference to the accompanying drawings, on the electronic book page number identification device of the present invention and on the electronic books with the device.

### First Embodiment

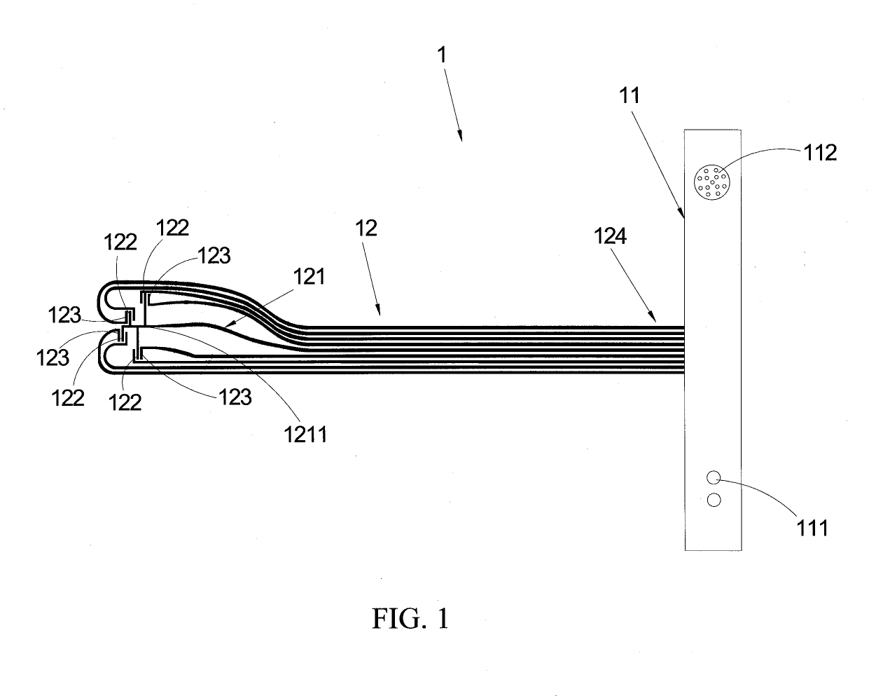

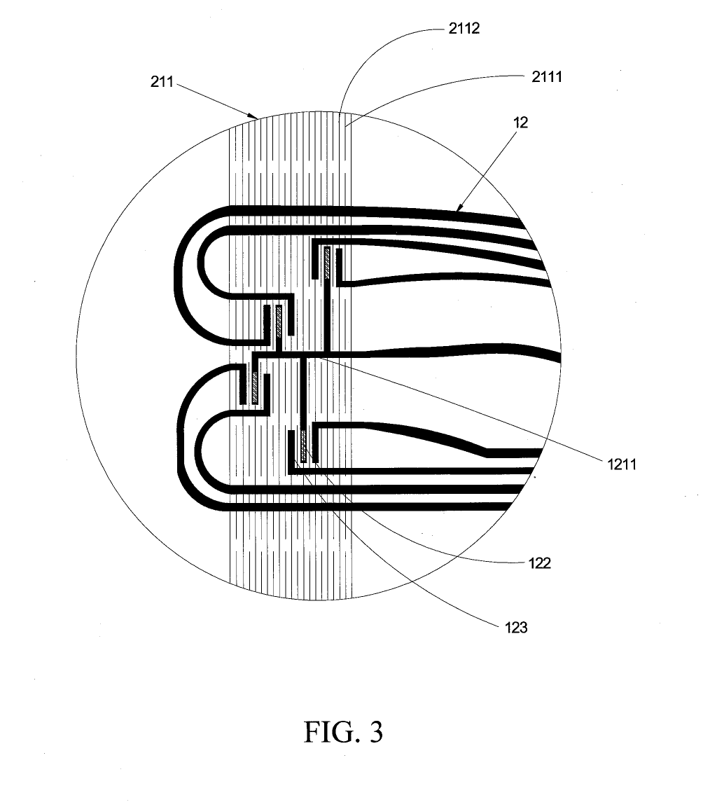

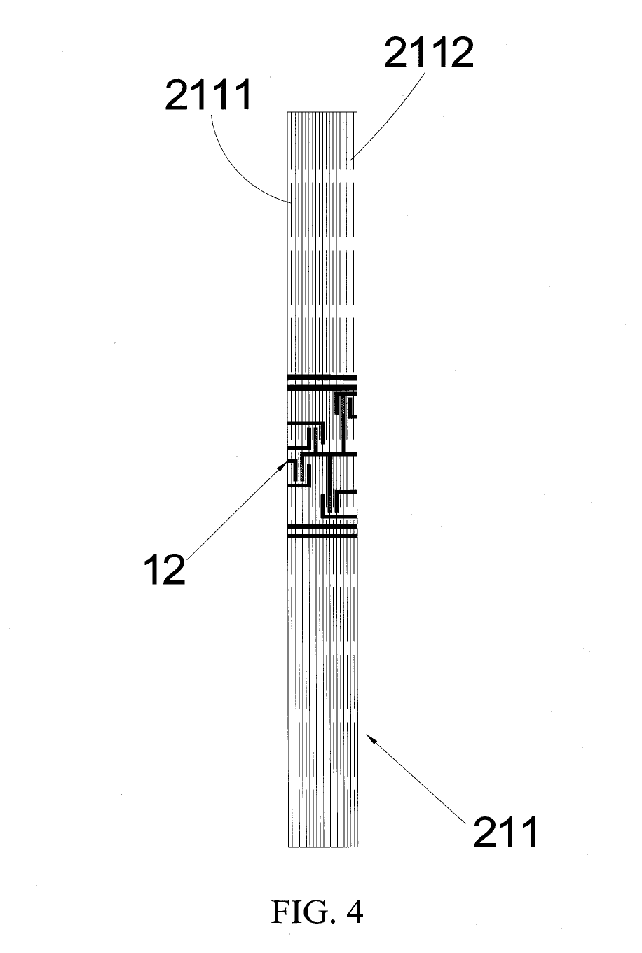

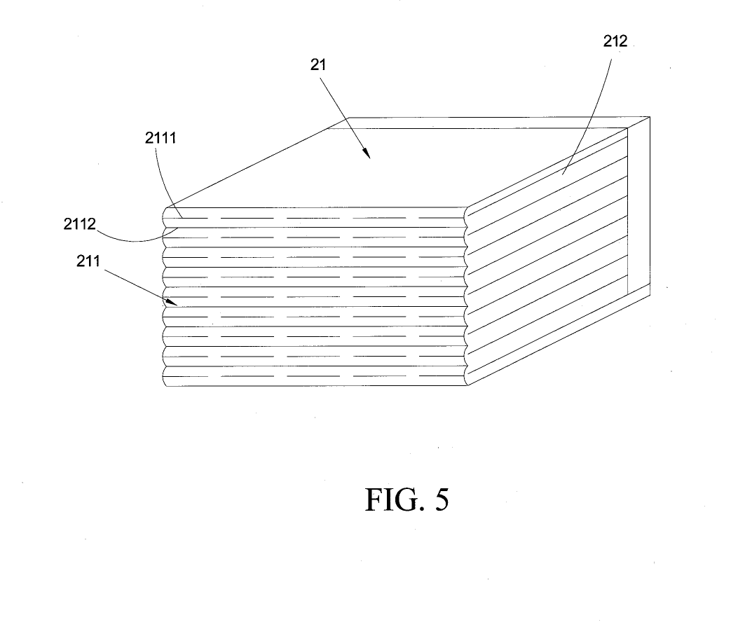

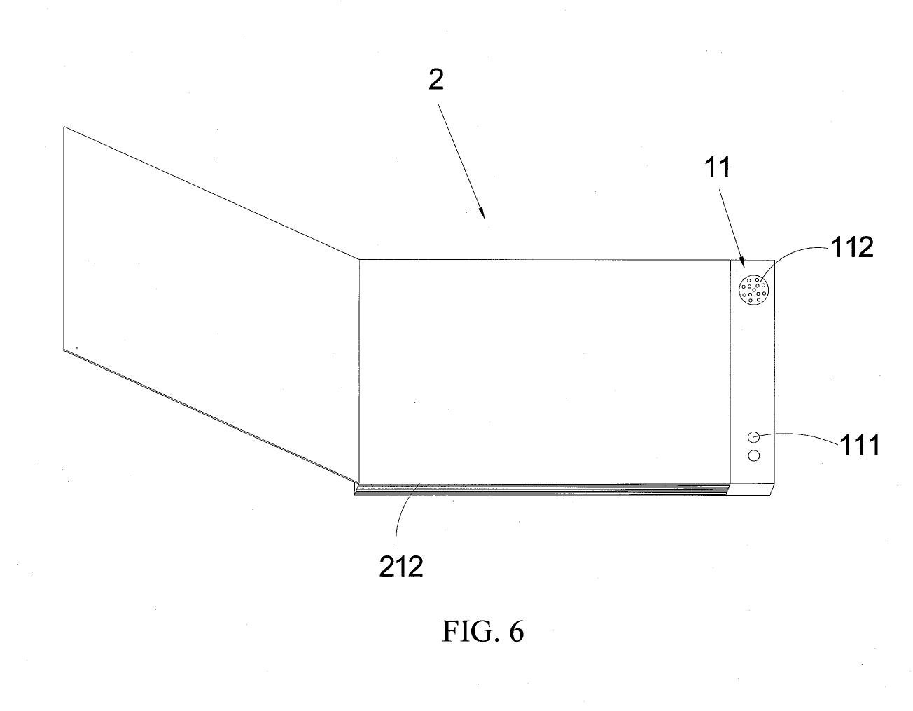

A preferred embodiment provided with the present invention is as illustrated in FIGS. 1 to 10.

In the present invent, the electronic book page number identification device 1 is designed to automatically identify the page number of page 212 of the electronic book 2 and play the content of page 212. The book body 21 of the electronic book 2 comprises a plurality of pages 212. The pages 212 are piled one above another to form the book body 21. One end of the book body 21 is piled immovably to form the book spine 211 of the book body 21, while the other end is piled movably to enable user flips pages 212 at this end of the book body 21. The electronic book page number identification device 1 includes a controller 11, a soft circuit 12 and positioning trigger pins 122. The controller 11 can receive signals from the soft circuit 12, output corresponding messages and carry out appropriate operations according to the signals. User can set built-in pre-programs for the controller 11 according to the practical arrangement of the soft circuit 12 and positioning trigger pins 122. On one end of the soft circuit 12, there is a contact end which can be affixed to the book spine 211. The positioning trigger pin 122 is electrically connected to the controller 11 by being disposed on the contact end, it can be inserted into the book spine 211, upon a page 212 of the electronic book 2 is flipped, different contact ends on the book spine 211 are connected through the positioning trigger pin 122, thus the soft circuit 12 is conducted. The controller 11 receives the message, identifies the page number of the flipped page 212 according to the build-in settings, and carries out appropriate operations, i.e., plays the preset content of the page 212. In some other embodiments, the positioning trigger pin 122 is non-electrically connected to the controller 11.

In the embodiment, the positioning trigger pin 122 is inserted into the book spine 211. As the positioning trigger pin 122 is fixed in an insertion manner, it is convenient for assembly, which brings high production efficiency and low cost. In addition, no displacement of the positioning trigger pin 122 during use makes operations reliable. Compared with the prior art, the positioning trigger pin 122 has lower requirements on thickness of page 212 of the electronic book 2. Without thick pages 212, it can still be inserted, so applicability is strong. Moreover, as the positioning trigger pin 122 is disposed on the top of the contact end of the soft circuit 12, the soft circuit 12 provides a support protection, which prevents the positioning trigger pins 122 from being squeezed into pages 212 under pressure, and ensures the repetitive operations of the electronic book page number device 1.

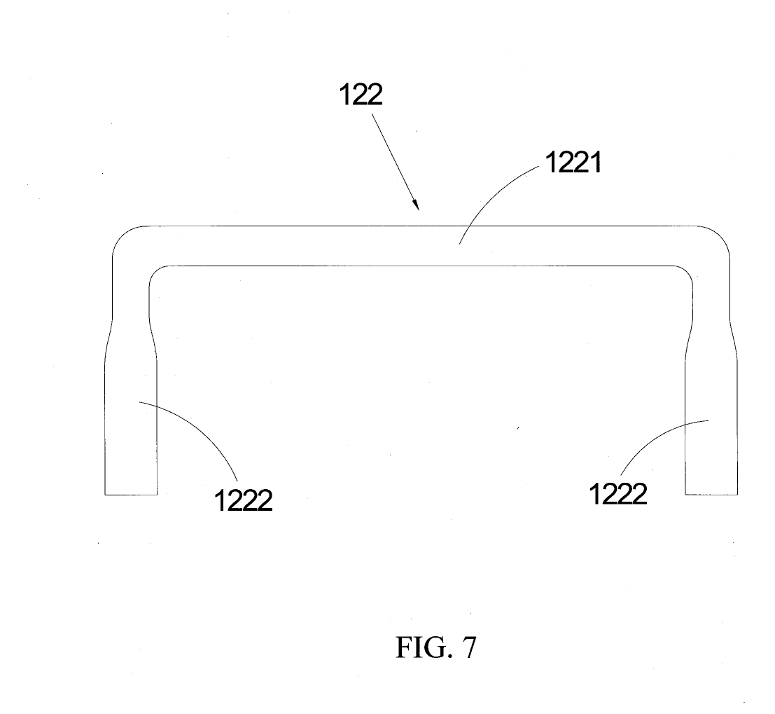

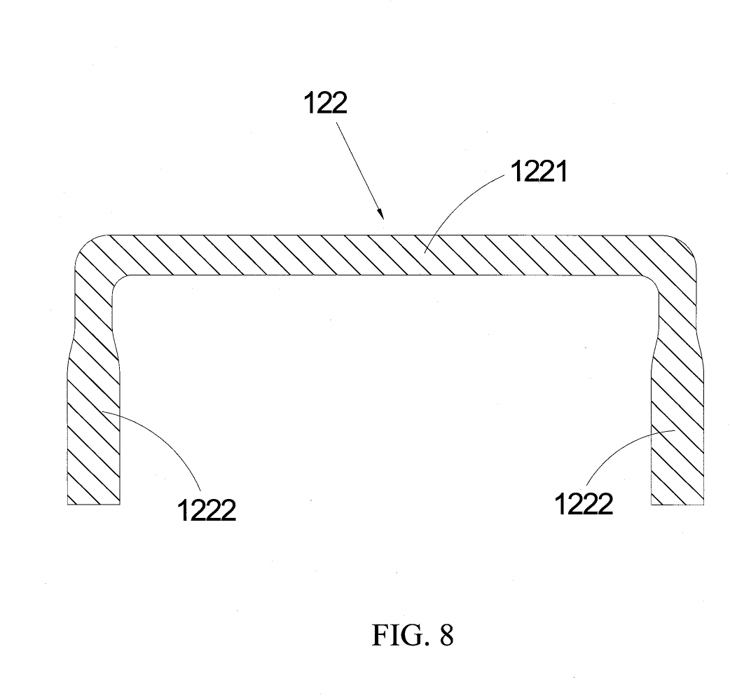

As illustrated in FIGS. 7 and 8, the positioning trigger pin 122 in the embodiment is shaped like a staple. It comprises a body 1221 and insertion pins 1222 arranged on the body 1221. The insertion pins 1222 can be inserted into the book spine 211, and the insertion pins 1222 are disposed on the contact end. The body 1221 contacts closely with the contact end so as to electrically connect the positioning trigger pin 122 with the controller 11. In practical use, the insertion pins 1222 of the positioning trigger pin 122 are inserted into the book spine 211. As the positioning trigger pin 122 has insertion pins 1222, it is easy to mount the positioning trigger pin 122.

In the embodiment, the body 1221 of the positioning trigger pin 122 has two insertion pins 1222, each of them is respectively arranged on one side of the body 1221. Of course, if desired, user can set up one or more insertion pins 1222. The insertion pin 1222 can also be arranged at other places of the body 1221, so long as the positioning trigger pin 122 can be arranged on the book spine 211.

In the embodiment, when the contact end contacts closely with the positioning trigger pin 122, the body 1221 of the positioning trigger pin 122 contacts closely with the contact end. The body 1221 of the positioning trigger pin 122 takes the shape of a cylinder, which is in favor of close contact between the contact end and the positioning trigger pin 122. And the insertion pin 1222 is of flat shape, which is convenient to insert the insertion pin 1222 into the book spine 211, and the flat shape has no influence on the appearance of pages 212. Of course, the body 1221 and the insertion pin 1222 of the positioning trigger pin 122 can be set to other shapes according to practical demands

In some other embodiments, the positioning trigger pin 122 comprises a body. The body takes the shape of a cylinder.

In the embodiment, the material of the positioning trigger pin 122 is metal. The advantage is that the positioning trigger pin 122 does not deform during use, thus the page number device 1 has a long service life and reliable operations. Of course, the positioning trigger pin 122 can also be made of other non-conductive rigid materials followed by being covered with a conductive coating. thus after a page is flipped, two contact ends are conducted to each other through the conductive positioning trigger pin 122, consequently the soft circuit 12 is conducted, realizing the goal of identifying the page 212.

Particularly, the soft circuit 12 comprises a second line 121 and a plurality of first lines that are independent of one another. The contact end of the soft circuit 12 comprises first contact ends 123 which are on one end of the first lines and a common contact end 1211 which is on one end of the second line 121. The other ends of both the first line and second line 121 are connection ends 124, and the connection ends 124 are connected into the controller 11 and electrically connected to the controller 11. The positioning trigger pin 122 is electrically connected to the controller 11 through the common contact end 1211 disposed on the second line 121, thus when a page 212 is flipped, the first contact end 123 on the book spine 211, corresponding to the flipped page 212, squeezes the corresponding positioning trigger pin 122, to conduct the first contact end 123 with the common contact end 1211, i.e., the first contact end 123 and the common contact end 1211 electrically connect with each other, consequently the soft circuit 12 is conducted and the trigger controller 11 carries out preset actions according to the received message.

According to customers' needs, the common contact end 1211 can be set to high potential, low potential or zero potential when it is connected to the controller 11. Of course, it can also be customized to other electric signals.

In the embodiment, the second line 121 is zero potential when it is conducted to the controller 11, so the common contact end 1211 is also zero potential. As the positioning trigger pin 122 passes through the common contact end 1211, it is zero potential as well.

In order to save production cost and increase production efficiency, in the embodiment, the contact ends of the soft circuit 12 are divided into groups to form contact end groups. The specific grouping includes: according to the order in which page numbers of pages 212 are arranged, each common contact end 1211, two first contact ends 123 on the both sides of the common contact 1211 and the positioning trigger pin 122 arranged at the common contact end 1211 form a contact end group. The soft circuit 12 has a plurality of contact end groups. Thus according to the abovementioned grouping rules, the contact ends on the book spine 211 of the electronic book 2 are arranged to make every positioning trigger pin 122 can identify the page numbers of two adjacent book pages 212, which reduces the amount of used positioning trigger pins 122.

In the embodiment, contact end groups of the soft circuit 12 are staggered in the direction that the page numbers of pages 212 are arranged. Thus the layout of the contact end groups on the book spine 211 is more reasonable and more space-efficient. It also avoids false triggering of the controller 11 caused by wrong contact among contact end groups.

In order to facilitate the layout of the soft circuit 12 on the book spine 211, in the embodiment, the common contact end 1211 of the second line 121, arranged on the book spine 211, has a plurality of branch lines. The branch lines are electrically connected to each other. Thus corresponding to the position of a contact end group, the adjacent branch line of the common contact end 1211 can be led to the contact end group.

In cases of grouping contact ends, if the electronic book 2 comprises an odd number of pages, grouping can be performed according to the page number order of book pages 212. The last remaining page alone forms a group, and it can be identified and controlled by a single contact end and a common contact end 1211.

In the embodiment, there are eight pages 212 to be identified for the electronic book 2, so the soft circuit 12 has four contact end groups, each with a positioning trigger pin 122. Thus there are four positioning trigger pins 122 for the page number identification device 1. In the embodiment, a button 111 can be arranged for the controller 11 as needed to perform the corresponding operations.

In order to facilitate the broadcast of the controller 11, a speaker mouth 112 is arranged on the controller 11, through which the sounds from the controller 11 can be sent out and easily heard by users.

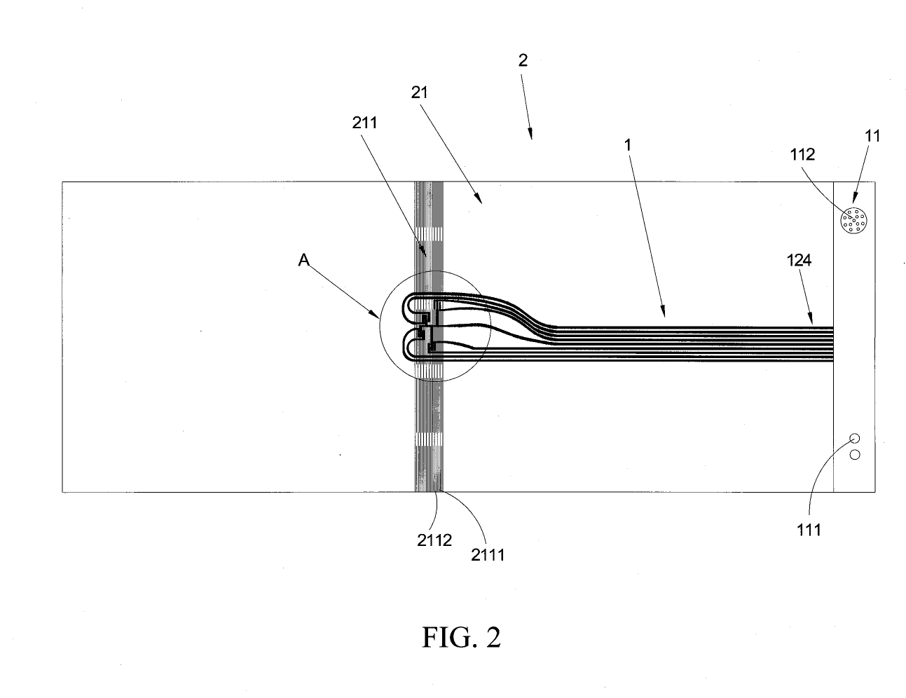

As illustrated in FIGS. 2-6, the embodiment of the present invention also provides an electronic book 2. The electronic book 2 includes a book body 21 and the abovementioned electronic book page number identification device 1. The soft circuit 12 of the device 1 is affixed to the outermost page 212 of the book body 21. The contact end is affixed to the book spine 211 of the book body 21. The positioning trigger pin 122 is inserted into the book spine 211. The controller 11 is arranged on one side of the book body 21.

The electronic book 2 adopts the abovementioned page number identification device 1 to identify a page number of page 212, thus the electronic book 2 has the advantages of convenient assembly, high production efficiency, low cost and reliable operations during use.

In the embodiment, on the book spine 211 of the book body 21, there are high parts 2111 and low parts 2112, i.e., the low part 2112 is formed between a book page 212 and adjacent book page 212, the high part 2111 is formed by mounting and bending a book page 212. The high parts 2111 and the low parts 2112 are distributed alternatively on the book spine 211.

In order to the contact end may contact closely with the positioning trigger pin 122 and the page number identification device 1 may obtain the signal about the page number of a book page 212, the contact end and the positioning trigger pin 122 are arranged on the low parts 2112 of the book spine 211, which is easy to mount the positioning trigger pin 122 and has no influence on the book appearance; and the natural cambered surface formed by the low parts 2112 makes the contact end adequately contact with the cylindrical body 1221 of the positioning trigger pin 122.

### Second Embodiment

As another embodiment of the present invention, the difference between this embodiment and a first embodiment is that: according to the built-in pre-program settings of the controller, the soft circuit only includes a plurality of third lines that are independent of one another; a trigger end of the soft circuit is a third contact end which is on one end of the third line and can be affixed to the book spine. Through the third contact end disposed on the third line, the positioning trigger pin is electrically connected to the third contact end on which it is disposed, thus electrically connected to the controller. When a page is flipped, the contact ends of two third lines are connected to each other through the positioning trigger pin, the soft circuit is consequently conducted and the controller carries out corresponding actions according to the conduction conditions.

In the embodiment, there are eight pages to be identified for the electronic book. The soft circuit has nine third lines, i.e., it has nine third contact ends. It also has four positioning trigger pins. According to the order in which the third contact ends are affixed to the book spine, the four positioning trigger pins are respectively disposed on the second, fourth, sixth and eighth contact ends and are all inserted on the book spine, thus when a page of the electronic book is flipped, the corresponding third contact ends on the book spine are connected through the positioning trigger pin,

Of course, according to the different built-in preset program settings, the third line and the positioning trigger pin may has different arrangements, not limited to the cases described above.

The foregoing are only preferred embodiments of the present invention, and are not intended to limit the present invention. Within the spirit and principles of the present invention, any modifications, equivalent replacement, improvement, etc., should be included within the scope of protection of the present invention.

What is claimed is:

1. A method for identifying electronic book page number, comprising: positioning trigger pins and a contact end are arranged on a book spine, the contact end being electrically connected to a controller; upon a page of the electronic book is flipped, conducting two contact ends, of a soft circuit which is closely affixed on the book spine, by squeezing a positioning trigger pin; receiving the conduction signal of the contact ends, identifying the page number of the flipped page according to the received signal, and playing the preset content of the book page through the controller electrically connected to the soft circuit.

2. An electronic book page number identification device, configured to automatically identify the page number of a page of an electronic book and play the content of the page; including a controller and a soft circuit electrically connected to the controller; one end of the soft circuit comprising a contact end which can be closely affixed on the book spine of the electronic book; wherein: the device also includes positioning trigger pins arranged at the contact end of the book spine; the contact end is electrically connected to the controller; the positioning trigger pin is electrically or non-electrically connected to the controller.

3. An electronic book page number identification device as claimed in claim 2, characterized in that: the positioning trigger pin comprises a body and insertion pins which are arranged on the body and can be inserted into the book spine; the insertion pin is disposed on the contact end; the body contacts closely with the contact end.

4. An electronic book page number identification device as claimed in claim 3, characterized in that: the body takes the shape of a cylinder and the insertion pin is of flat shape.

5. An electronic book page number identification device as claimed in claim 2, characterized in that: the positioning trigger pin comprises a body; the positioning trigger pin is under the contact end of the soft circuit and between the soft circuit and the book spine; the contact end is electrically connected to the controller, while the positioning trigger pin is non-electrically connected to the controller.

6. An electronic book page number identification device as claimed in claim 5, characterized in that the body takes the shape of a cylinder.

7. An electronic book page number identification device as claimed in claim 2, characterized in that: the soft circuit comprises a second line and a plurality of first lines that are independent of one another; the contact end comprises a first contact end which is on one end of the first line and a common contact end which is on one end of the second line; the positioning trigger pin is arranged at the common contact end.

8. An electronic book page number identification device as claimed in claim 7, characterized in that: according to the order in which the page numbers of pages are arranged, each common contact end, two first contact ends on both sides of the common contact end and the positioning trigger pin arranged at the common contact end form a contact end group.

9. An electronic book page number identification device as claimed in claim 8, characterized in that: if the electronic book page number identification device comprises a plurality of contact end groups, the contact end groups are staggered in the direction that the page numbers of pages are arranged.

10. An electronic book page number identification device as claimed in claim 2, characterized in that: the soft circuit comprises a plurality of third lines that are independent of one another; the contact end is a third contact end which is on one end of the third line; the positioning trigger end is arranged on the third contact end.

11. An electronic book, including a book body, characterized in that the electronic book also includes an electronic book page number identification device as claimed in claim 2; the soft circuit of the electronic book page number identification device is affixed to the outermost page of the book body; the contact end is affixed to the book spine; the positioning trigger pin is arranged at the book spine.

12. An electronic book as claimed in claim 11, characterized in that: the book spine has high parts formed by mounting and bending book pages and low parts between pages; the high parts and low parts are distributed alternatively on the book spine; the contact end and the positioning trigger pin are arranged on the low parts.
